(19) United States
(12) Patent Application Publication
(10) Pub. No.: US 2023/0225524 A1
(43) Pub. Date: Jul. 20, 2023

(54) GOODS PRESENTATION SYSTEM

(71) Applicant: KESSEBOEHMER HOLDING KG, BAD ESSEN (DE)

(72) Inventors: HEIKO KETTLER, BAD ROTHENFELDE (DE); JENS WISCHMEYER, BAD ESSEN (DE)

(73) Assignee: KESSEBOEHMER HOLDING KG, BAD ESSEN (DE)

(21) Appl. No.: 18/098,117

(22) Filed: Jan. 18, 2023

(30) Foreign Application Priority Data
Jan. 20, 2022 (DE) 10-2022 101 342.1

(51) Int. Cl. A47F 5/08; A47F 5/10; F16B 12/40

(52) U.S. Cl. CPC A47F 5/083; A47F 5/10; F16B 12/40

(57) ABSTRACT

A goods presentation system includes a pedestal, a wall unit which is releasably secured to the pedestal, and a securing device for securing the wall unit to the pedestal. The securing device is fitted on the pedestal and is secured thereto. The pedestal and the wall unit form an L-shaped cross section or a T-shaped cross section when viewed from a side. At least one base is securable to the wall unit.

### CROSS REFERENCE TO PRIOR APPLICATIONS

Priority is claimed to German Patent Application No. DE 10 2022 101 342.1, filed Jan. 20, 2022. The entire disclosure of said application is incorporated by reference herein.

### FIELD

The present invention relates to a goods presentation system for presenting goods, the goods presentation system having a pedestal and a wall unit which is secured to the pedestal so that the pedestal and the wall unit form an L-shaped or a T-shaped cross section when viewed from the side. Bases on which goods can be placed for presentation can be secured to the wall unit.

### BACKGROUND

In a goods presentation system having an L-shaped cross section, the goods to be presented are typically placed at one side of the wall unit, while in a goods presentation system having a T-shaped cross section, goods can be placed at both sides of the wall unit.

Apparatuses for presenting and/or storing goods are in many applications items of furniture which are not permanently erected in a saleroom, but which must instead be provided as necessary, for example, for a specific sales promotion.

Apparatuses for presenting and/or storing goods have previously been described, for example, in DE 20 2020 106 573 U1.

### SUMMARY

An aspect of the present invention is to provide a goods presentation system which can be provided in a particularly space-saving and consequently cost-effective manner.

In an embodiment, the present invention provides a goods presentation system which includes a pedestal, a wall unit which is configured to be releasably secured to the pedestal, and a securing device for securing the wall unit to the pedestal. The securing device is fitted on the pedestal and is secured thereto. The pedestal and the wall unit form an L-shaped cross section or a T-shaped cross section when viewed from a side. At least one base is securable to the wall unit.

### BRIEF DESCRIPTION OF THE DRAWINGS

The present invention is described in greater detail below on the basis of embodiments and of the drawings in which:

FIG. 1 shows an embodiment of the goods presentation system according to the present invention in the assembled state;

FIG. 2 shows a first embodiment of the goods presentation system in a partially exploded illustration;

FIG. 3 shows a detailed illustration from FIG. 2;

FIG. 4 shows the goods presentation system according to FIG. 2 in a partially assembled state;

FIG. 5 shows a detailed illustration from FIG. 4;

FIG. 6 shows the goods presentation system according to FIG. 2 in a completely mounted state;

FIG. 7 shows a detailed illustration from FIG. 6;

FIG. 8 shows a second embodiment of the goods presentation system in a partially exploded illustration;

FIG. 9 shows a detailed illustration from FIG. 8;

FIG. 10 shows the exploded illustration according to FIG. 2 from another perspective;

FIG. 11 shows a detailed illustration from FIG. 10;

FIG. 12 shows the goods presentation system according to FIG. 8 in a partially assembled state;

FIG. 13 shows a detailed illustration from FIG. 12;

FIG. 14 shows the goods presentation system according to FIG. 8 in a completely assembled state;

FIG. 15 shows a detailed illustration from FIG. 14;

FIG. 16 shows a third embodiment of the goods presentation system;

FIG. 17 shows a detailed illustration from FIG. 16;

FIG. 18 shows the goods presentation system according to FIG. 16 in an exploded illustration;

FIG. 19 shows a detailed illustration from FIG. 18;

FIG. 20 shows the goods presentation system according to FIG. 16 in a partially assembled state;

FIG. 21 shows a detailed illustration from FIG. 20;

FIG. 22 shows an exploded illustration of the securing device of the goods presentation system according to FIG. 16;

FIG. 23 shows a side view of the securing device of the goods presentation system according to FIG. 16;

FIG. 24 shows a cross sectional view of the securing device of the goods presentation system according to FIG. 16 along the line X-X of FIG. 23;

FIG. 25 shows a top view of the securing device of the goods presentation system according to FIG. 16;

FIG. 26 shows the pedestal and securing device of another embodiment of the goods presentation system in an exploded illustration;

FIG. 27 shows a detailed illustration from FIG. 26;

FIG. 28 shows the pedestal and securing device according to FIG. 26 in a partially assembled state;

FIG. 29 shows a detailed illustration from FIG. 28;

FIG. 30 shows the pedestal and securing device according to FIG. 26 in a completely assembled state; and

FIG. 31 shows a detailed illustration from FIG. 30.

### DETAILED DESCRIPTION

The present invention provides a goods presentation system which comprises a securing device for securing the wall unit to the pedestal, wherein the securing device is fitted on the pedestal and is secured thereto.

The use of a securing device which can be fitted on the pedestal makes it possible for the pedestal and securing device to be stored or packed separately from each other. A plurality of pedestals can consequently be arranged one on top of the other in a particularly space-saving manner for dispatch. The compact arrangement of the pedestals is not impeded by a securing device which may protrude. Storage costs and dispatch costs for such a goods presentation system are thereby reduced. After delivery, the securing device can be fitted in a simple manner on the pedestal and be secured thereto.

The securing device can, for example, be releasably secured to the pedestal. The term “releasably” in this instance is intended to be understood to mean that the securing device can be separated from the pedestal in a destruction-free manner so that it can be subsequently releasably secured to the pedestal again. The securing device can then be released from the pedestal again for further transport or in particular for longer-term storage.

The pedestal can, for example, have at least one recess in which the securing device is introduced. The securing device can be fitted on the pedestal by being introduced into the recess. The fact that the securing device can be introduced into at least one recess of the pedestal provides a goods presentation system which can be provided in a simple manner, wherein the wall unit is securely connected to the pedestal via the securing device. The securing device which is introduced into the recess is arranged in a stable manner on the pedestal and can reliably direct the forces which are introduced via the wall unit into the pedestal.

The securing device which is secured to the pedestal can, for example, form a mandrel, and the wall unit can, for example, have a pillar which is in the form of a hollow profile and which is fitted on the securing device which is in the form of a mandrel. In such a goods presentation system, the pedestal and the wall unit can be secured to each other in a particularly simple manner or separated from each other via the securing device by the wall unit being fitted on the securing device which is secured to the pedestal or being removed therefrom. The securing device is in particular formed by a pipe portion, by a shaped portion, or by a joint portion.

The securing device can, for example, be constructed in an H-shaped or a U-shaped manner with two legs. The two legs have in this instance a continuation at the end in each case. The pedestal has two recesses which correspond to the continuations of the H-shaped or U-shaped securing device and in which the respective continuations are introduced. An H-shaped or U-shaped securing device which is secured to the legs via two continuations in two corresponding recesses of the pedestal is particularly stable.

The securing device can, for example, be constructed as a U-shaped, bent sheet metal component. Securing devices which are constructed as a U-shaped, bent sheet metal component can be produced in a simple and cost-effective manner.

The continuations can, for example, each have a wedge receiving member, wherein a wedge which releasably fixes the securing device to the pedestal is introduced into the wedge receiving member. A securing device which is releasably secured to the pedestal can be fixed in a particularly simple manner via such a wedge.

The wedge which is introduced into the wedge receiving members can, for example, be secured to the pedestal via a securing screw. The wedge is secured in the wedge receiving members via such a securing screw. This prevents the wedge and consequently the securing device from being unintentionally released from the pedestal. The wall unit of the goods presentation system is thereby safely secured to the pedestal.

The securing device can, for example, have a threaded rod. The pedestal thereby has a corresponding threaded rod recess through which the threaded rod is guided. The securing device is thereby secured to the pedestal via the threaded rod and a nut which is securely screwed thereto. The securing device can thus be safely and releasably secured to the pedestal in a simple manner.

The securing device can, for example, have an inner thread. The pedestal thereby has a screw recess through which a screw which cooperates with the inner thread of the securing device and via which the securing device is securely screwed to the pedestal is guided. The securing device can thus be safely and releasably secured to the pedestal in a simple manner.

The two above-mentioned embodiments in which the securing device is screwed to the pedestal can be produced with more generous production tolerances and consequently in a more cost-effective manner than the embodiment with a wedge and wedge receiving member. A wedge connection must provide that the wedge receiving members are accessible for the wedge prior to the securing of the securing device and are not partially concealed by any curved surfaces, layers of paint, or ridges in the pedestal. Wedge receiving members which are concealed in this manner are not accessible for a wedge.

The securing device can, for example, be in the form of a U-shaped bent sheet metal component having two legs with continuations which are arranged at the end of the legs and which are introduced into corresponding recesses in the pedestal. The inner thread is thereby in the form of a nut which is arranged between the legs of the securing device which is in the form of a U-shaped, bent sheet metal component and which is in particular welded. A securing device which is constructed as a U-shaped sheet metal component and which is secured via two continuations to the legs in two corresponding recesses of the pedestal is particularly stable. The securing device can be provided with an inner thread in a simple manner via the arrangement of a nut between the legs.

The continuations can, for example, each have sheet metal strip receiving members, wherein a sheet metal strip is introduced into the sheet metal strip receiving members of a securing device. The sheet metal strip distributes the forces which are applied by a screw to the pedestal. The releasable connection of the securing device to the pedestal is particularly stable.

The securing device can, for example, have a wall unit thread via which the wall unit is screwed to the securing device. The wall unit is not only fitted on the securing device, but is also screwed thereto. Such a vertical orientation of the wall unit is thus in particular improved. The goods presentation system is thereby more stable and has a higher load-bearing capacity.

The wall unit thread can, for example, be in the form of a wall unit nut which is arranged between the legs of the U-shaped, bent sheet metal component and which is in particular welded. The wall unit nut may in this instance in particular be arranged in a state rotated through 90° with respect to a nut to secure the securing device to the pedestal. The wall unit may be connected to the securing device via a horizontally arranged screw connection, while the securing device can be connected to the pedestal via a vertically arranged screw connection.

The securing device and the pedestal can, for example, form an auxiliary assembly positioning member for a correct assembly of the securing device on the pedestal. This is particularly advantageous when the securing device, in particular a securing device which is in the form of a U-shaped sheet metal component, has a recess in order not to impede bases from being received on a pillar of the wall unit. In this instance, the auxiliary assembly positioning member prevents the securing device from being mounted in an incorrect orientation and, in spite of the recess which is provided on the securing device, impairing the receiving of bases on the pillar of the wall unit. The auxiliary assembly positioning member can in this instance in particular be formed via an asymmetrically arranged wedge receiving members or via sheet metal strip receiving members, wherein a hole in the sheet metal strip or in the wedge through which a screw is intended to be guided only corresponds in the correct assembly position to a corresponding recess in the pedestal. A fixing of the sheet metal strip or a securing of the wedge to the pedestal is in this instance only possible with a correct orientation of the securing device.

Other advantages and details of the present invention can be derived from the following description of the drawings which show exemplary embodiments according to the present invention. Components which are identical or which have a similar function (where appropriate) are thereby given identical reference numerals. Individual technical features of the embodiments described below can be combined with the features of individual embodiments described above to form objects according to the present invention.

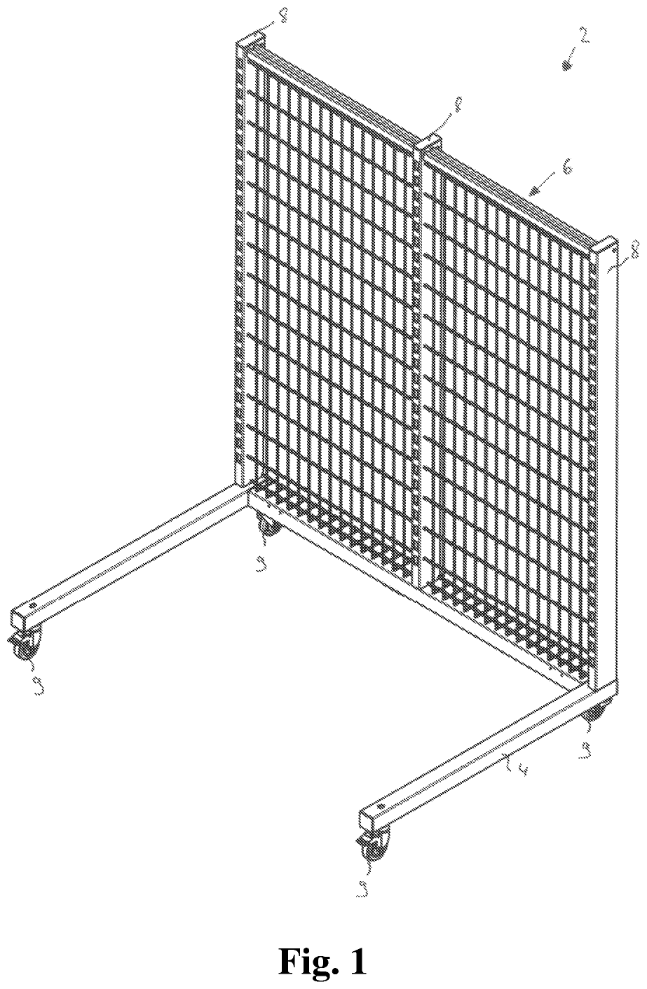

FIG. 1 shows a goods presentation system 2 having a pedestal 4 and a wall unit 6 in an assembled state. The wall unit 6 has three pillars 8 which are in the form of a hollow profile, and on which bases (which are not shown in the drawings) can be secured. The pillars 8 are provided with corresponding recesses therefor. Rollers 9 are arranged on the pedestal 4.

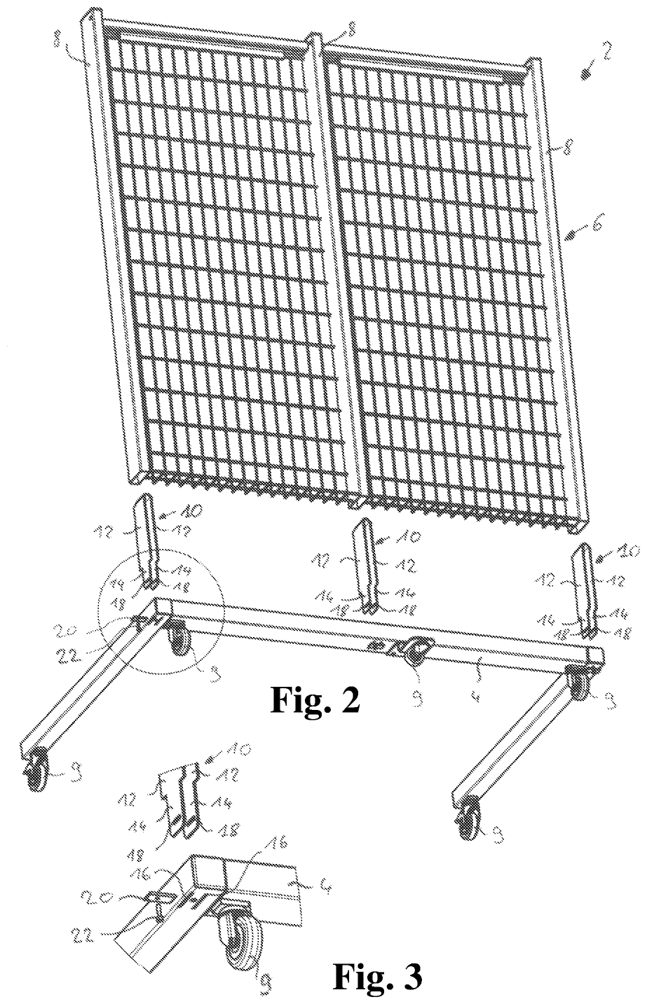

FIG. 2 shows a first embodiment of the goods presentation system 2 in an exploded illustration. On the pedestal 4 are provided three securing devices 10 which are arranged so as to correspond to the pillars 8 of the wall unit 6. Each securing device 10 is in the form of a U-shaped sheet metal component. These U-shaped sheet metal components have legs 12 on the ends of which continuations 14 are arranged. Corresponding pairs of recesses 16 for the continuations 14 are provided on the pedestal 4. Wedge receiving members 18 for a wedge 20 are arranged in the continuations 14. The securing devices 10 are introduced with the continuations 14 into the corresponding recesses 16 on the pedestal 4 and are thereby fitted on the pedestal 4. Each wedge 20 is guided through a respective wedge receiving member 18 into the continuations 14 so as to releasably fix the securing device 10 to the pedestal 4. The wedge 20 can subsequently be screwed via a securing screw 22 and a thread which is arranged on the pedestal 4.

The securing devices 10 which are secured to the pedestal 4 form mandrels which can be introduced into the pillars 8 of the wall unit 6 which are in the form of a hollow profile or onto which the wall unit 6 with the pillars 8 which are in the form of a hollow profile is fitted.

In FIG. 2, the pedestal 4 is formed from hollow profiles which are welded to each other and which are arranged in a plane. Without the securing devices 10 which are arranged thereon, and in particular without the rollers 9 which are arranged thereon, the pedestal 4 can be packed, stored and dispatched in a particularly space-saving manner with additional pedestals 4. The goods presentation system 2 can then be assembled in a simple manner at the destination.

FIG. 3 shows a detailed cut-out of FIG. 2 where the cooperating components of the securing device 10 and the pedestal 4 are illustrated with the wedge 20 and the securing screw 22 to an enlarged scale.

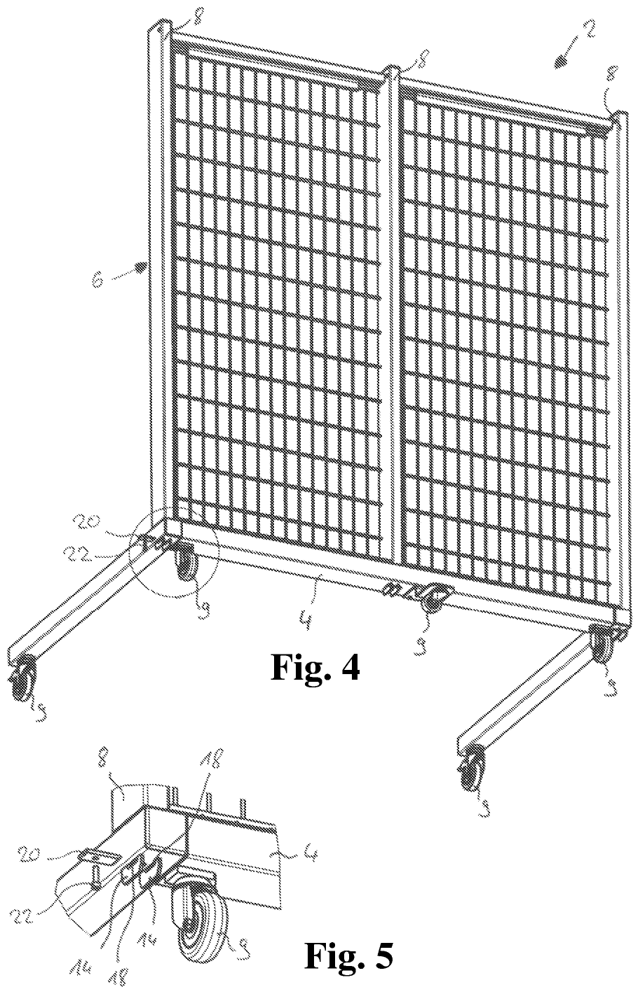

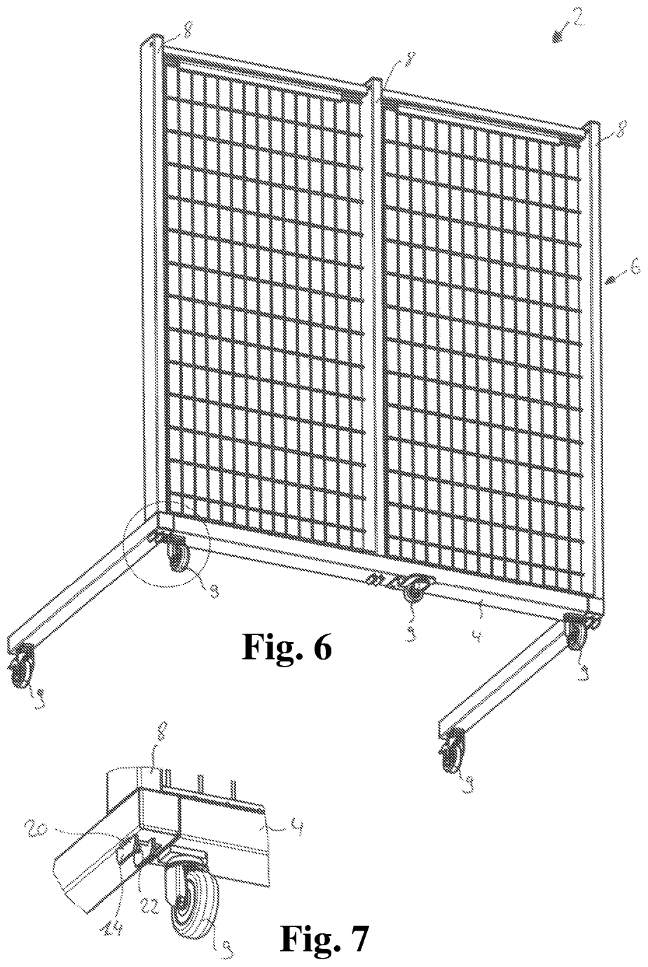

FIG. 4 and the associated detailed cut-out of FIG. 5 show the goods presentation system 2 in a partially assembled state. FIGS. 6 and 7 show the completely assembled goods presentation system 2.

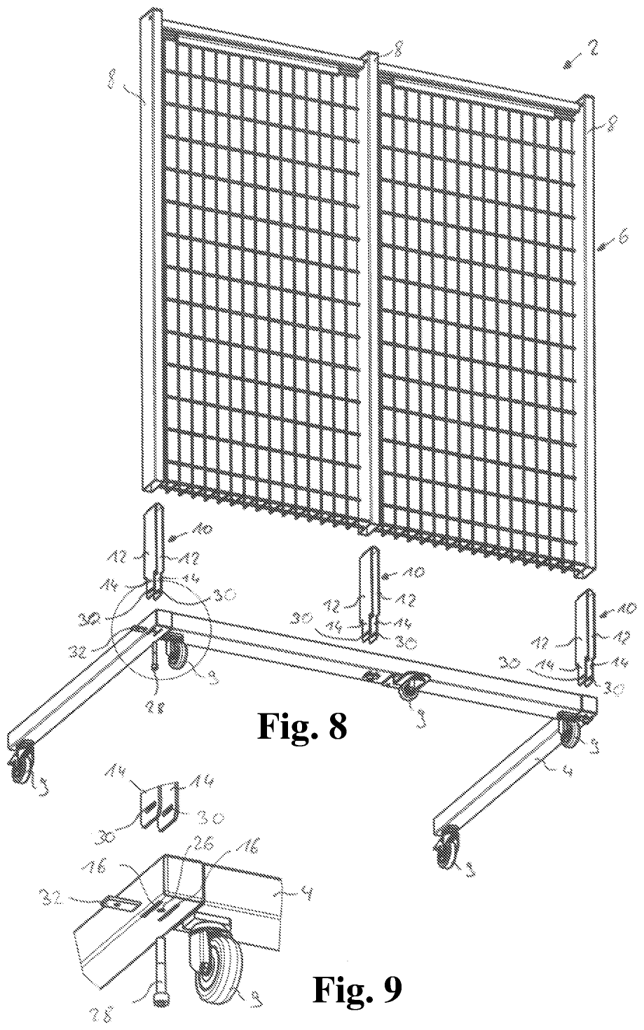

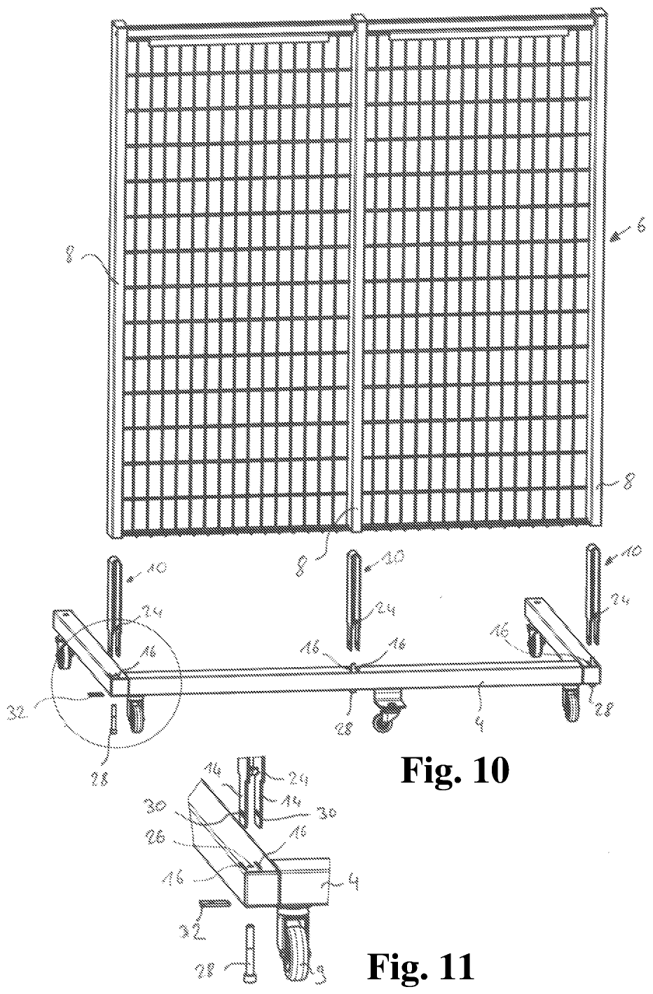

FIG. 8 shows a partially exploded illustration of an alternative embodiment of the goods presentation system 2. The securing devices 10 which are also in the form of U-shaped sheet metal components also have continuations 14. The securing devices 10 are fitted on the pedestal 4 via the continuations 14 being introduced into the respective recesses 6 of the pedestal. A nut 24 is arranged between the legs 12 of the securing device 10 in each case, in particular welded. The nut 24 can be seen in FIG. 10 and the associated detailed illustration of FIG. 11. Screw recesses 26 through which a respective screw 28 is guided are arranged for each securing device 10 in the pedestal 4. The securing device 10 is screwed to the pedestal 4 via the screw 28 and the nut 24.

In the continuations 14 of the legs 12 of the securing device 10 are arranged sheet metal strip receiving members 30 in which a sheet metal strip 32 is introduced in each case. The sheet metal strip 32 has a hole through which the screw 28 is guided. The sheet metal strip 32 serves to distribute the forces which are applied by the screw 28 to the pedestal 4. The releasable connection between the securing device 10 and pedestal 4 is thereby more durable.

The sheet metal strip receiving members 30 are, with respect to a center plane in a viewing direction of the securing device 10 from the side, introduced in a state which is offset in an outward direction into the continuations 14 of the legs 12. An auxiliary assembly positioning member is thereby formed. Only when the securing devices 10 are introduced into the recesses 16 in a correct orientation can the screw 28 be guided through the hole in the sheet metal strip 32 and the corresponding screw recess 26 in the pedestal 4 in order to screw the securing devices 10 to the pedestal 4. An assembly of the securing devices 10 in an incorrect orientation is thereby prevented. An assembly of the securing devices 10 in a correct orientation is important since the securing devices 10 which are in the form in the embodiments of U-shaped bent sheet metal components have a lateral recess in the base of the U. This lateral recess is intended to be arranged to face forwards so as to prevent the securing devices 10 from concealing base recesses which are provided for receiving bases on the pillars 8 of the wall unit 6.

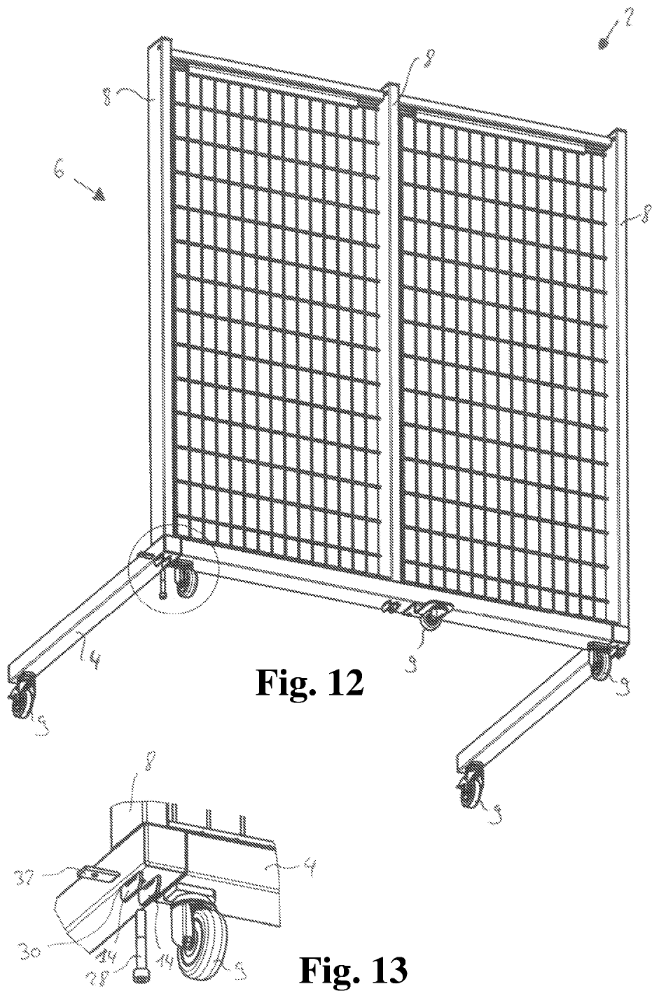

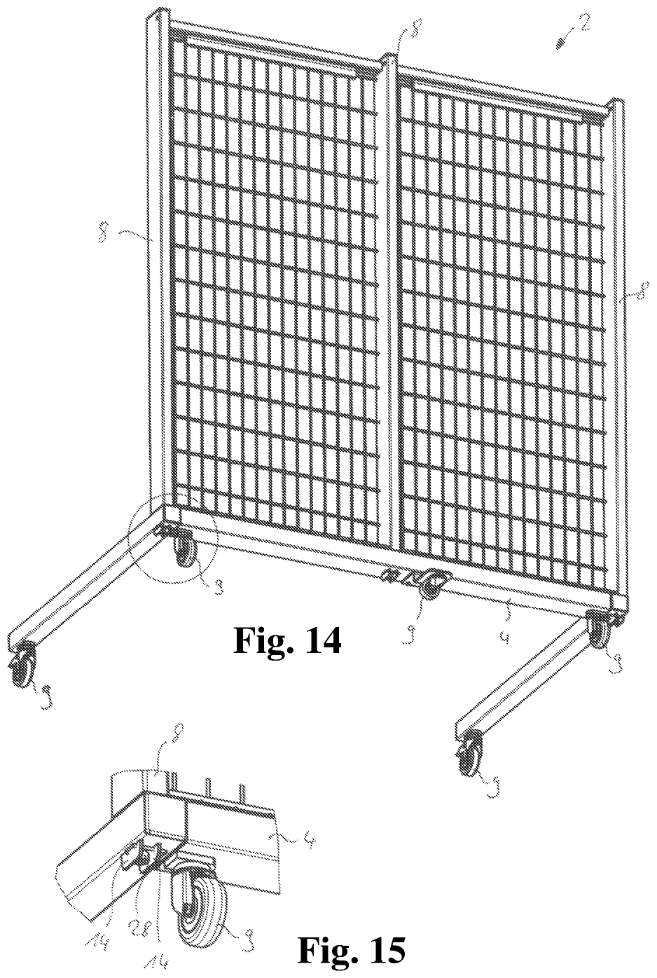

FIGS. 12 and 13 show the goods presentation system 2 in a partially assembled state. FIGS. 14 and 15 show the completely assembled goods presentation system 2.

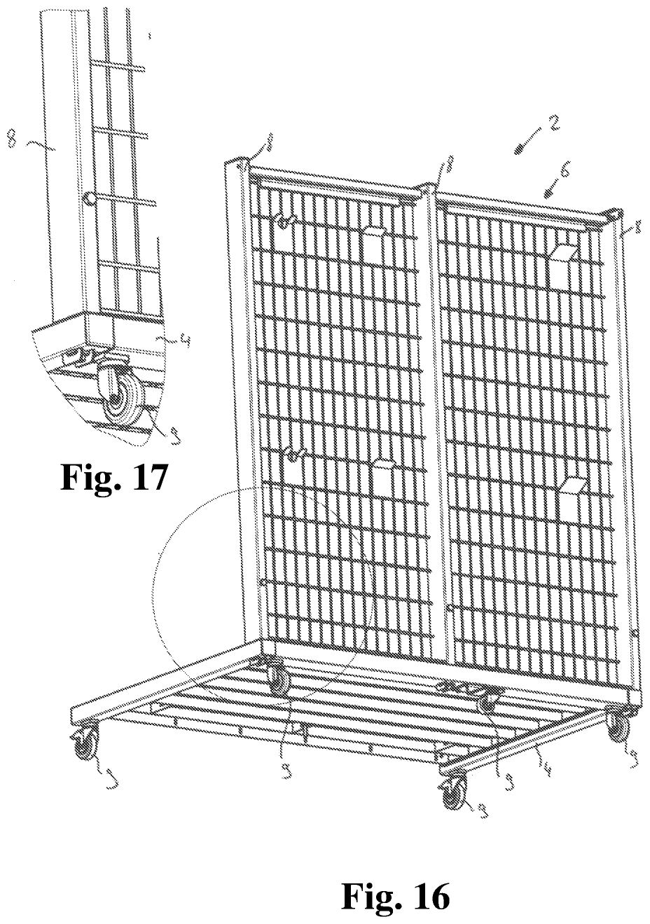

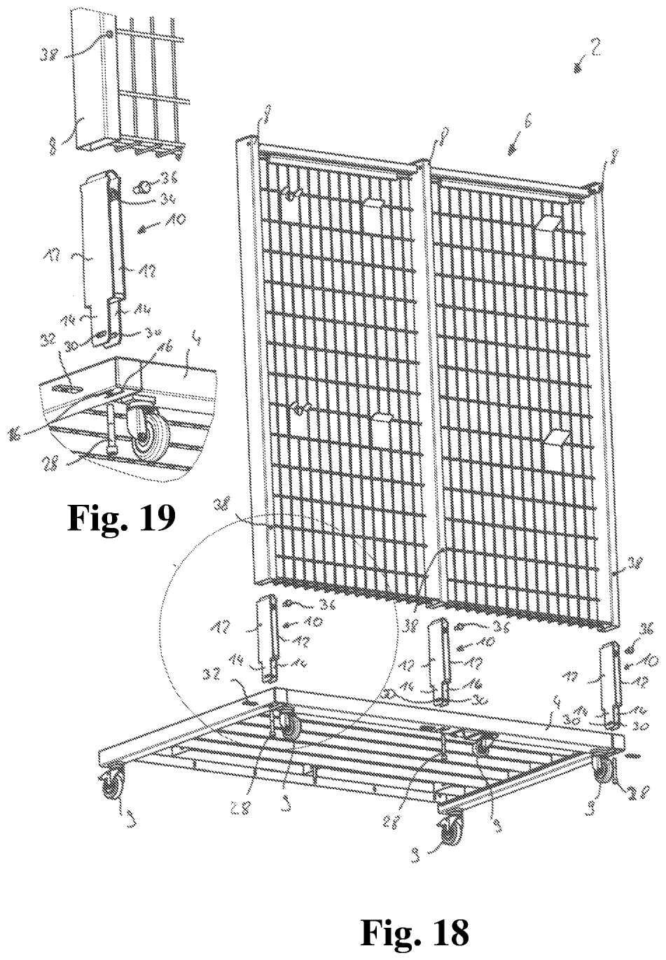

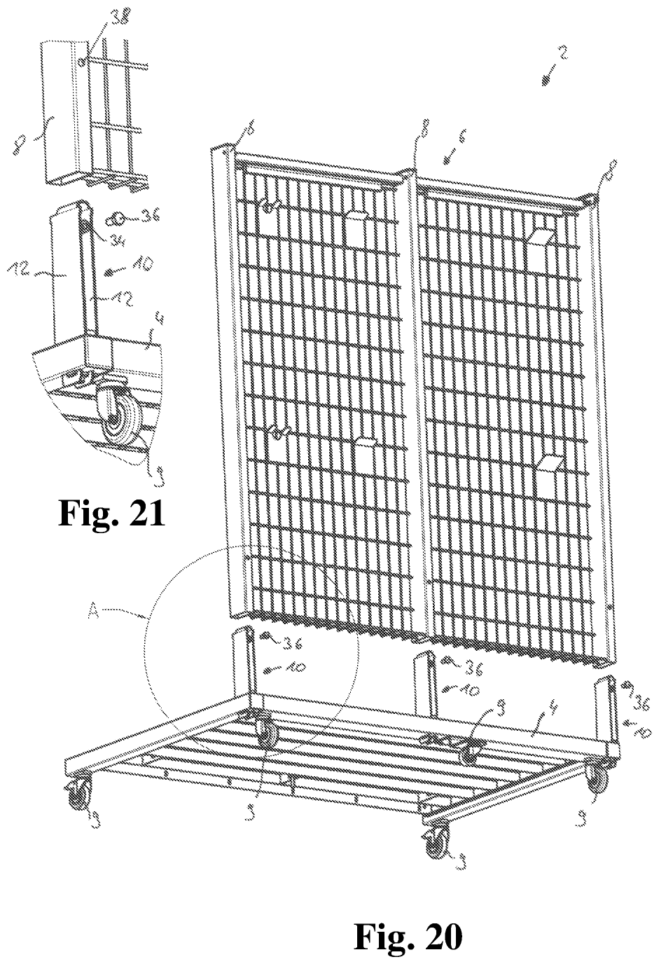

FIGS. 16 and 17 to FIGS. 20 and 21 show another embodiment of the goods presentation system 2. This embodiment is similar to the embodiment according to FIGS. 8 to 15. Each securing device 10 additionally has a wall unit nut 34. The pillars 8 of the wall unit 6 are provided with a recess 38. In the assembled state, a wall unit screw 36 is guided through the recess 38. The wall unit 6 is screwed thereto via the wall unit screw 36 and the wall unit nut 34 of the securing device 10. The vertical orientation of the wall unit 6 is thereby improved. Tilting moments which are introduced to the pillars 8 on the securing device 10 are reduced via an improved vertical orientation. The goods presentation system 2 therefore has a greater load-bearing capacity.

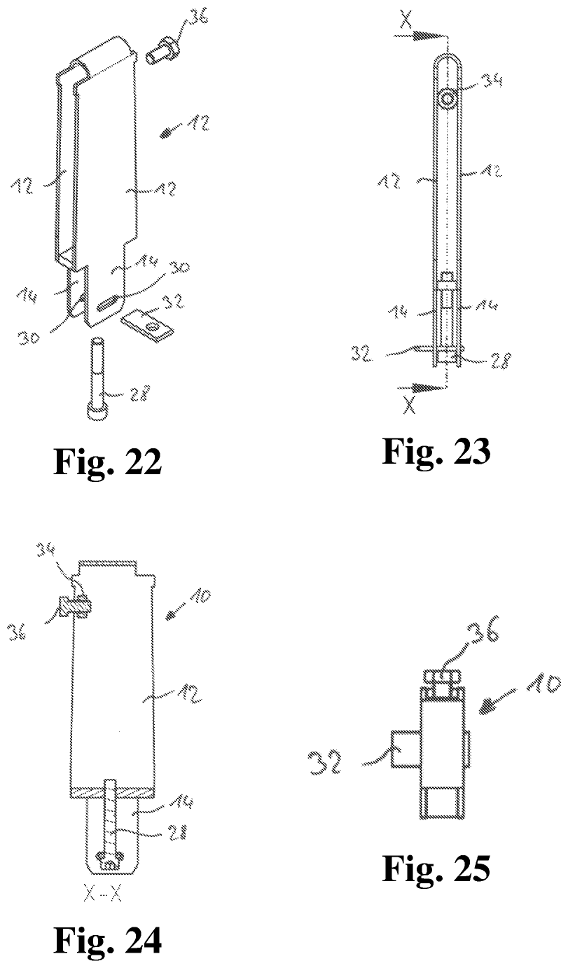

FIGS. 22 to 25 show the securing device 10 of the goods presentation system 2 according to FIGS. 9 to 11 in different views. FIG. 22 is an exploded illustration. FIGS. 23 to 25 show the securing device 10 with the sheet metal strip 32 secured thereto and the screw 28 which is guided through the hole in the sheet metal strip 32 and which is screwed into an inner thread of the securing device 10. The sheet metal strip 32 is introduced via sheet metal strip receiving members 30 into the continuations 14 of the legs 12 of the securing device 10 which is in the form of a U-shaped, bent sheet metal component. The wall unit screw 36 is introduced into the wall unit nut 34 of the securing device 10.

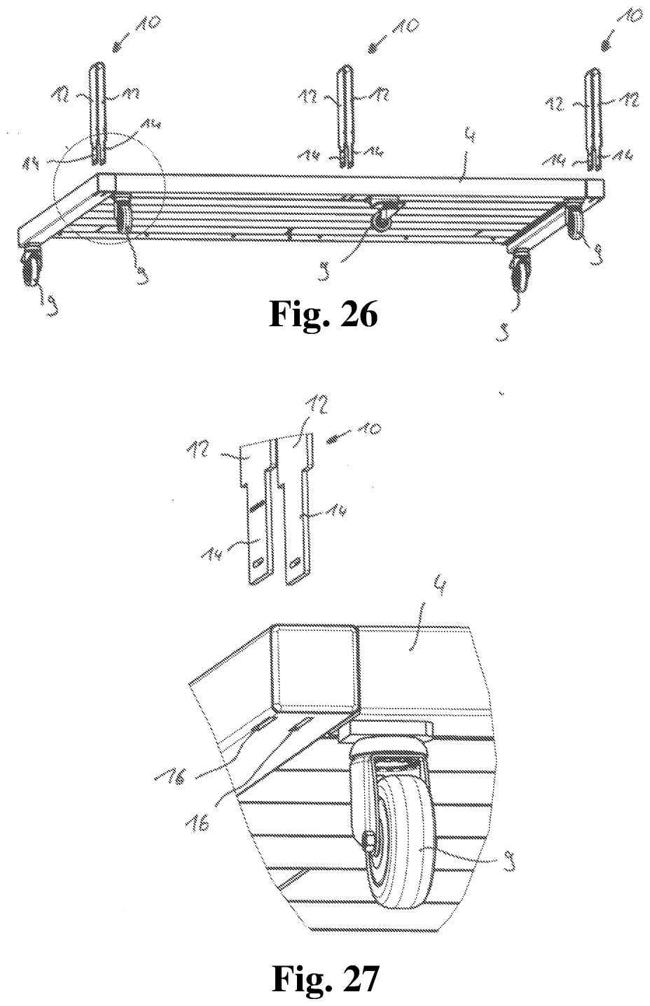

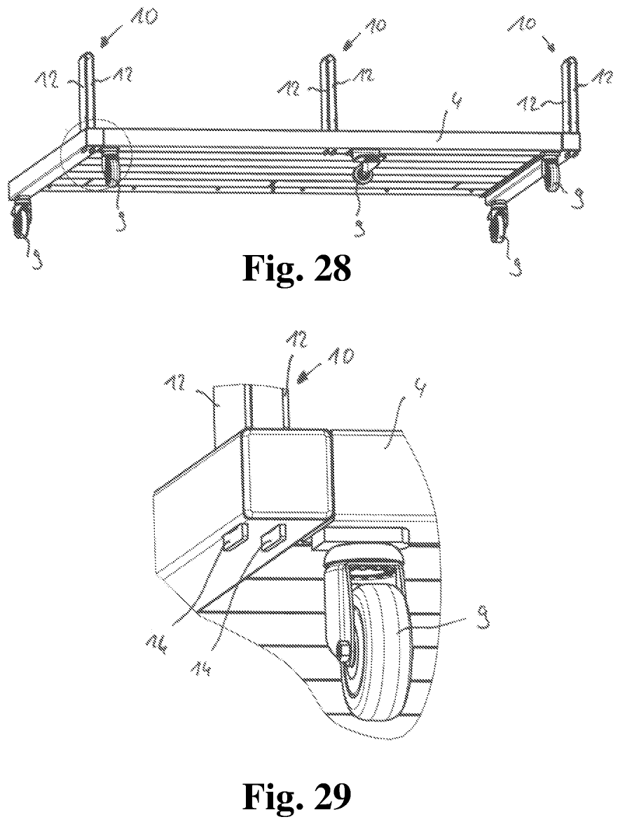

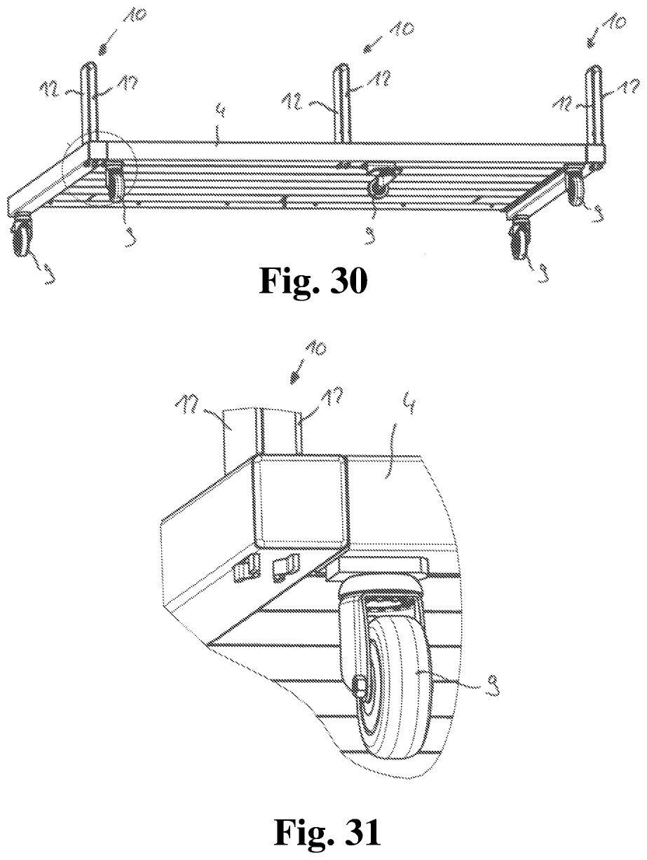

FIGS. 26 to 31 show a fourth embodiment of the goods presentation system 2 in which the securing devices 10 are secured to the pedestal 4 in a non-releasable manner. The securing devices 10 are again in the form of U-shaped, bent sheet metal components having legs 12 which have continuations 14. The continuations 14 are introduced into recesses 16 on the pedestal so as to fit the securing device 10 on the pedestal 4. The continuations 14 also have recesses. These recesses are used in this embodiment to be able to more easily deform portions of the continuations 14. As a result of the deformation of the continuations 14, the securing device 10 which are fitted via the introduction into the recesses 16 of the pedestal 4 are secured to the pedestal in a non-releasable manner, at least not releasable in a destruction-free manner.

The goods presentation systems 2 of the embodiments have L-shaped cross sections. These are typically provided with goods at one side of the wall unit 6. The goods presentation systems 2 can readily be produced with a T-shaped cross section, wherein the wall unit 6 can then be provided with goods at both sides.

The present invention is not limited to embodiments described herein; reference should be had to the appended claims.

### LIST OF REFERENCE NUMERALS

2 Goods presentation system
4 Pedestal
6 Wall unit
8 Pillar
9 Roller
10 Securing device
12 Leg
14 Continuation (of leg 12)
16 Recess
18 Wedge receiving member
20 Wedge
22 Securing screw
24 Nut
26 Screw recess
28 Screw
30 Sheet metal strip receiving member
32 Sheet metal strip
34 Wall unit nut
36 Wall unit screw
38 Recess

What is claimed is:

1. A goods presentation system comprising:
a pedestal;
a wall unit which is configured to be releasably secured to the pedestal; and
a securing device for securing the wall unit to the pedestal,
wherein,
the securing device is fitted on the pedestal and is secured thereto,
the pedestal and the wall unit form an L-shaped cross section or a T-shaped cross section when viewed from a side, and
at least one base is securable to the wall unit.

2. The goods presentation system as recited in claim 1, wherein the securing device is releasably secured to the pedestal.

3. The goods presentation system as recited in claim 1, wherein,
the securing device, when secured to the pedestal, forms a mandrel, and
the wall unit comprises a pillar having a hollow profile form which is configured to be fitted on the mandrel.

4. The goods presentation system as recited in claim 1, wherein the pedestal comprises a plurality of recesses which are configured to have the securing device be introduced therein.

5. The goods presentation system as recited in claim 4, wherein,
the securing device is provided in a form of a U-shaped, bent sheet metal component comprising two legs,
each of the two legs comprises a continuation arranged at an end thereof, and
each continuation is configured to be arranged in corresponding one of the plurality of recesses of the pedestal.

6. The goods presentation system as recited in claim 5, further comprising:
a sheet metal strip,
wherein,
each continuation of the securing device comprises a sheet metal strip receiving member, and
the sheet metal strip is configured to be introduced into the sheet metal strip receiving members.

7. The goods presentation system as recited in claim 5, further comprising:
a wedge,
wherein,
each continuation of the security device comprises a wedge receiving member, and
the wedge is configured to be introduced into the wedge receiving members so as to releasably fix the securing device to the pedestal.

8. The goods presentation system as recited in claim 7, further comprising:
a securing screw which is configured to secure the wedge to the pedestal when the wedge is introduced into the wedge receiving members.

9. The goods presentation system as recited in claim 5, further comprising:
a screw,
wherein,
the securing device comprises an inner thread,
the pedestal comprises a screw recess, and
the securing device is secured to the pedestal via the screw being guided through the screw recess in the pedestal and being screwed into the inner thread of the securing device.

10. The goods presentation system as recited in claim 9, wherein the inner thread of the securing device is formed via a nut which is arranged between the two legs of the securing device.

11. The goods presentation system as recited in claim 10, wherein the nut is welded between the two legs of the securing device.

12. The goods presentation system as recited in claim 9, further comprising:
a sheet metal strip,
wherein,
each continuation of the securing device comprises a sheet metal strip receiving member, and
the sheet metal strip is configured to be introduced into the sheet metal strip receiving members.

13. The goods presentation system as recited in claim 1, further comprising:
a nut,
wherein,
the pedestal comprises a threaded rod recess,
the securing device comprises a threaded rod which is configured to be guided through the threaded rod recess in the pedestal, and
the securing device is secured to the pedestal via the threaded rod being guided through the threaded rod recess in the pedestal and the nut being screwed onto the threaded rod.

14. The goods presentation system as recited in claim 1, wherein the securing device comprises a wall unit nut via which the wall unit is screwed onto the securing device.

15. The goods presentation system as recited in claim 1, wherein the securing device and the pedestal form an auxiliary assembly positioning member so as to provide for a correct assembly of the securing device on the pedestal.
